(19) United States
(12) Patent Application Publication
(10) Pub. No.: US 2025/0240091 A1
(43) Pub. Date: Jul. 24, 2025

(54) NETWORK-BASED BACKUP BATTERY SYSTEM

(71) Applicant: Charter Communications Operating, LLC, St. Louis, MO (US)

(72) Inventor: Charles Cook, Castle Rock, CO (US)

(21) Appl. No.: 18/418,202

(22) Filed: Jan. 19, 2024

(51) Int. Cl. H04B 10/03; H04B 10/079

(52) U.S. Cl. CPC H04B 10/03; H04B 10/0793; H04B 10/07955

(57) ABSTRACT

Obtain, at a monitoring server of a network, usage data from a plurality of traffic sensors associated with a plurality of devices of interest of a plurality of network users. Based on the obtained usage data, create a plurality of traffic profiles for the plurality of devices of interest of the plurality of network users. From time to time, cause first signals to be sent, based on the plurality of traffic profiles, to the plurality of devices of interest. The first signals cause the plurality of devices of interest to enter a low power mode during first times. From time to time, cause second signals to be sent, based on the plurality of traffic profiles, to the plurality of devices of interest. The second signals cause the plurality of devices of interest to leave the low power mode for a normal power mode during second times.

### FIELD OF THE INVENTION

The present invention relates generally to the electrical, electronic and computer arts, and, more particularly, to broadband networks such as hybrid fiber-coaxial (HFC) networks, fiber to the home (FTTH) networks (also called fiber to the premises (FTTP) networks, fiber to the curb (FTTC) networks, and the like.

### BACKGROUND OF THE INVENTION

Due to regulatory requirements, a cable modem (CM) must have a battery backup mechanism if it supports voice communications. Conventional DOCSIS® (Data Over Cable Service Interface Specification) CMs are backed up using an external battery backup unit (EBBU) that requires a communication link between the CM and the EBBU. EBBUs are also used with equivalent elements in a fiber solution such as a service optical network unit (ONU). Functionally, the external battery backup device maintains a fully charged backup battery (typically 12 volts (V)) and switches from the main power (typically 120 V) to the backup battery when the main power fails (backup battery mode). When the main power is restored, the external battery backup device switches from the backup battery to the main power.

### SUMMARY OF THE INVENTION

Principles of the invention provide a network-based backup battery system. In one aspect, an exemplary method includes the operations of obtaining, at a monitoring server of a network, usage data from a plurality of traffic sensors associated with a plurality of devices of interest of a plurality of network users; based on the obtained usage data, creating a plurality of traffic profiles for the plurality of devices of interest of the plurality of network users; from time to time, causing first signals to be sent, based on the plurality of traffic profiles, to the plurality of devices of interest, the first signals causing the plurality of devices of interest to enter a low power mode during first times; and from time to time, causing second signals to be sent, based on the plurality of traffic profiles, to the plurality of devices of interest, the second signals causing the plurality of devices of interest to leave the low power mode for a normal power mode during second times.

In another aspect, another exemplary method includes: providing, to a monitoring server of a network, usage data from a traffic sensor associated with a device of interest of a network user; from time to time, obtaining at least a first signal from the monitoring server of the network, the at least first signal causing the cable modem to enter a low power mode during at least a first time, based on a traffic profile created for the device of interest using the usage data; and, from time to time, obtaining at least a second signal from the monitoring server of the network, the at least second signal causing the device of interest to leave the low power mode for a higher power mode during at least a second time, based on the traffic profile.

In still another aspect, a non-transitory computer readable medium includes computer executable instructions which when executed by a computer cause the computer to perform a method including the steps of: obtaining, at a monitoring server of a network, usage data from a plurality of traffic sensors associated with a plurality of devices of interest of a plurality of network users; based on the obtained usage data, creating a plurality of traffic profiles for the plurality of devices of interest of the plurality of network users; from time to time, causing first signals to be sent, based on the plurality of traffic profiles, to the plurality of devices of interest, the first signals causing the plurality of devices of interest to enter a low power mode during first times; and from time to time, causing second signals to be sent, based on the plurality of traffic profiles, to the plurality of devices of interest, the second signals causing the plurality of devices of interest to leave the low power mode for a normal power mode during second times.

In a further aspect, a monitoring server of a network includes: a memory; and at least one processor, coupled to the memory, and operative to: obtain usage data from a plurality of traffic sensors associated with a plurality of devices of interest of a plurality of network users; based on the obtained usage data, create a plurality of traffic profiles for the plurality of devices of interest of the plurality of network users; from time to time, cause first signals to be sent, based on the plurality of traffic profiles, to the plurality of devices of interest, the first signals causing the plurality of devices of interest to enter a low power mode during first times; and from time to time, cause second signals to be sent, based on the plurality of traffic profiles, to the plurality of devices of interest, the second signals causing the plurality of devices of interest to leave the low power mode for a normal power mode during second times.

In yet a further aspect, an apparatus includes: a cable modem; a switch; a power supply unit port selectively coupled to the cable modem through the switch; a battery selectively coupled to the cable modem through the switch; a processor coupled to the switch and the cable modem; and a sensor coupled to the power supply unit port and the battery and configured to sense a power supply unit failure condition. The processor is configured to implement a traffic sensor and provide, to a monitoring server of a network to which the apparatus is coupled, usage data from the traffic sensor. The cable modem is configured to: from time to time, obtain at least a first signal from the monitoring server of the network, the at least first signal causing the cable modem to enter a low power mode during at least a first time, based on a traffic profile created for the device of interest using the usage data; and from time to time, obtain at least a second signal from the monitoring server of the network, the at least second signal causing the cable modem to leave the low power mode for a higher power mode during at least a second time, based on the traffic profile.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed, or might facilitate an action taken by a switch, such as opening/closing. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
an integrated battery backup system that enables the size of a backup battery to be reduced while continuously providing backup battery support;
an integrated battery backup system that uses machine learning to generate profiles that capture network traffic patterns of a cable modem (or equivalent element in a fiber solution such as a service optical network unit) and identify when power is to be conserved, when a backup battery is to be tested, and the like.
an integrated battery backup system that minimizes thrashing when the main power source “flickers” in backup battery mode;
a battery monitoring server that assesses the condition of a backup battery by monitoring how rapidly the backup battery discharges;
a battery monitoring server that uses machine learning to identify the type and/or condition of a backup battery;
an integrated battery backup system that is capable of testing the individual cells of a backup battery while the backup battery continues to perform a battery backup function (in either an active or inactive battery backup state);
an integrated battery backup system that generates, using machine learning, profiles that characterize backup batteries of a power system such that the type of backup battery, the condition of the backup battery, and the like can be determined;
power and battery conservation for a power system provided by using a narrow bandwidth channel as the primary channel and enabling additional channels, as needed, when traffic is being transmitted; and
a solution that allows the system to operate and conserve power over time-thus enabling the system to be more energy efficient.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 is a block diagram of a first example battery backup cable modem system, in accordance with an example embodiment;

FIG. 11 is a block diagram of a second example battery backup cable modem system, in accordance with an example embodiment;

FIG. 12 is a block diagram of a third example battery backup cable modem system that incorporates a system that sends power over an Ethernet cable, in accordance with an example embodiment;

FIG. 13 is a block diagram of a fourth example battery backup cable modem system that incorporates a system that sends power over an Ethernet cable, in accordance with an example embodiment;

FIG. 14 is a block diagram of a fifth example battery backup cable modem system, in accordance with an example embodiment; and

FIG. 15 is a block diagram of a sixth example battery backup cable modem system, in accordance with an example embodiment.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

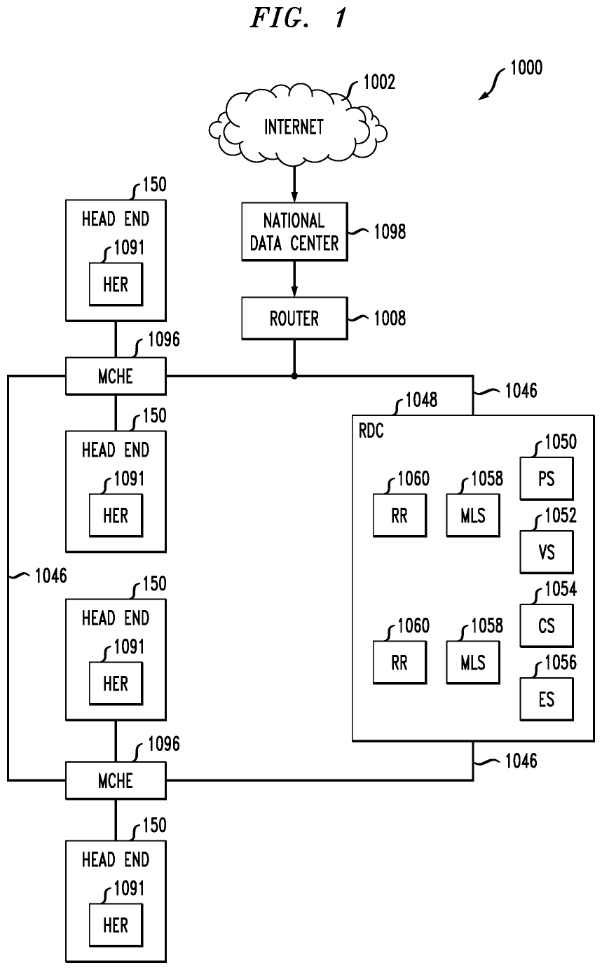

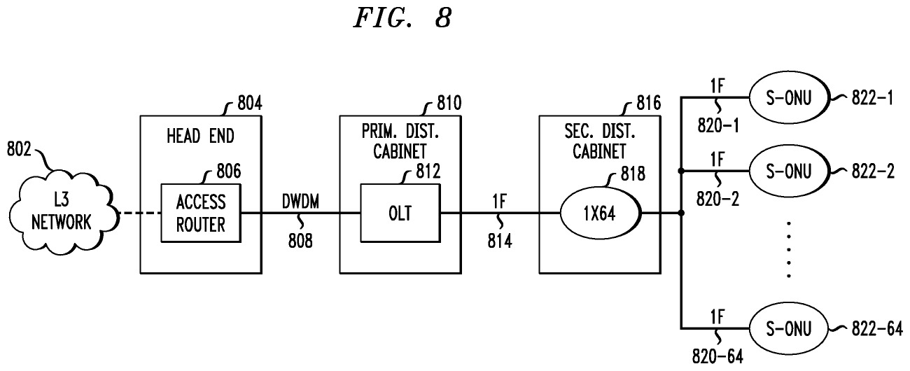

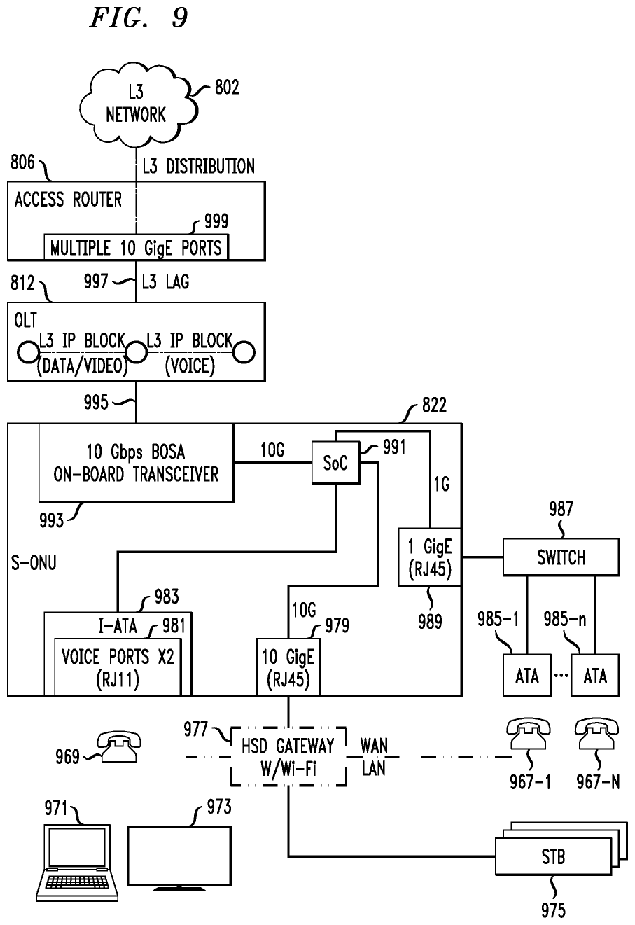

Purely by way of example and not limitation, some embodiments will be shown in the context of a cable multi-service operator (MSO) providing data services as well as entertainment services, it being understood that the example network of FIGS. 1-6 and the example network of FIGS. 8-9 are but two examples of many different networks that can employ monitoring in accordance with aspects of the invention. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

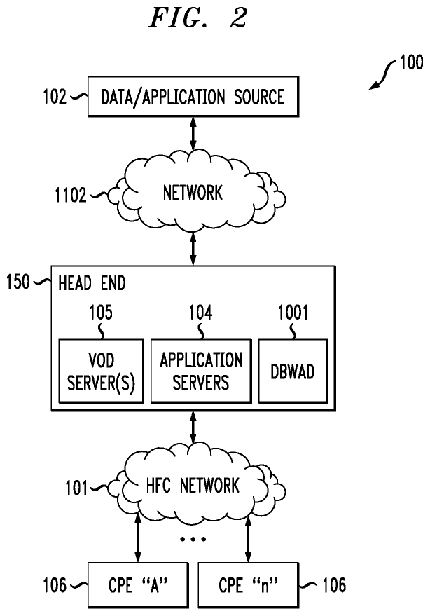

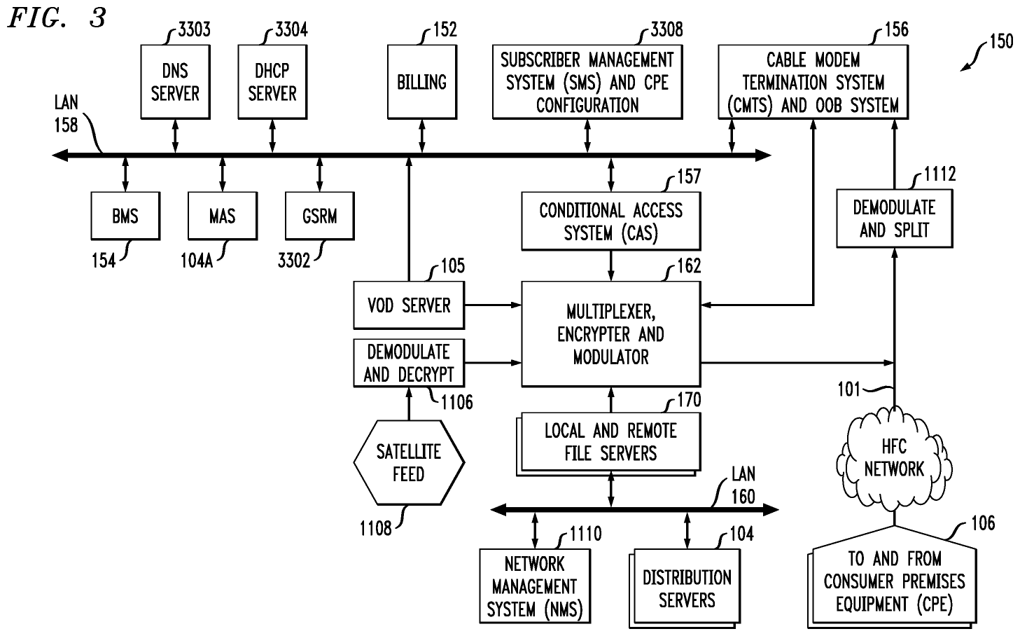

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein. Still further, cable modems 4028 discussed below can be stand-alone or integrated.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

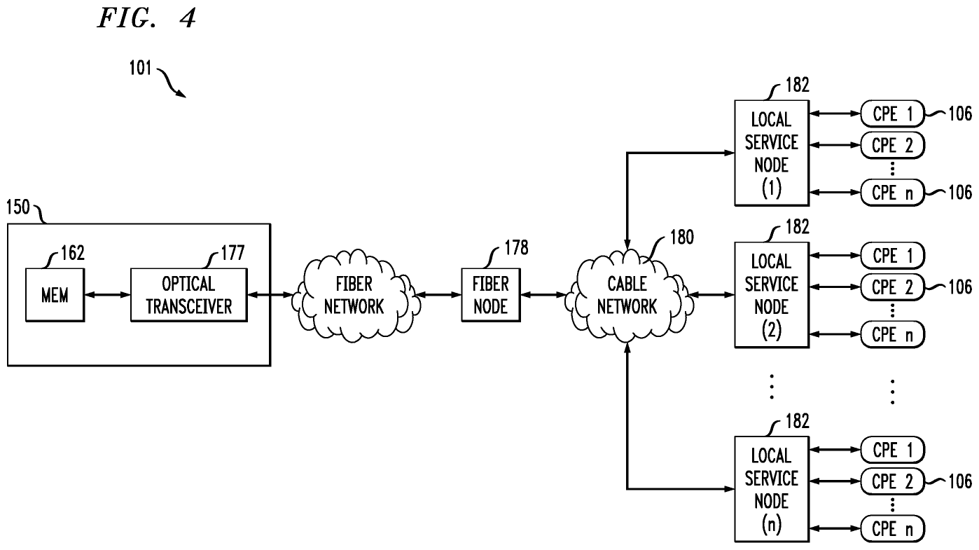

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

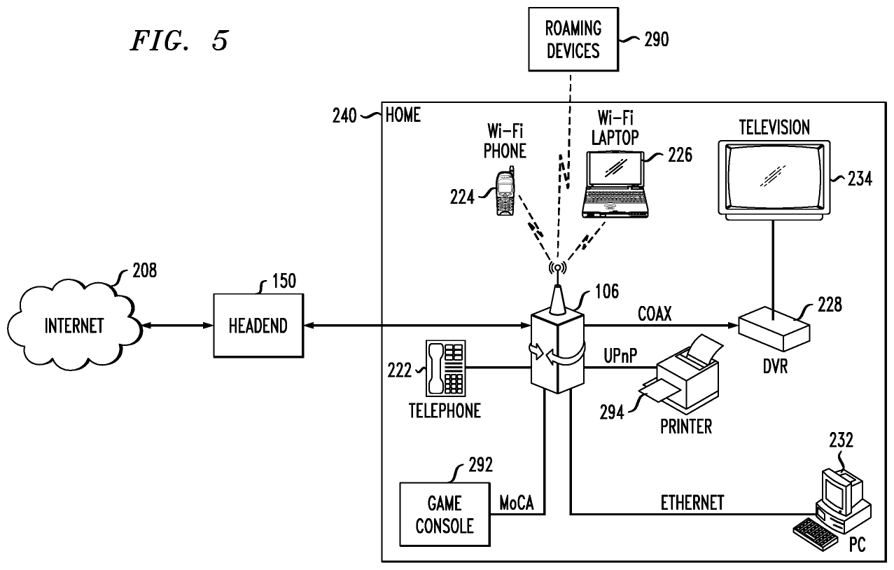

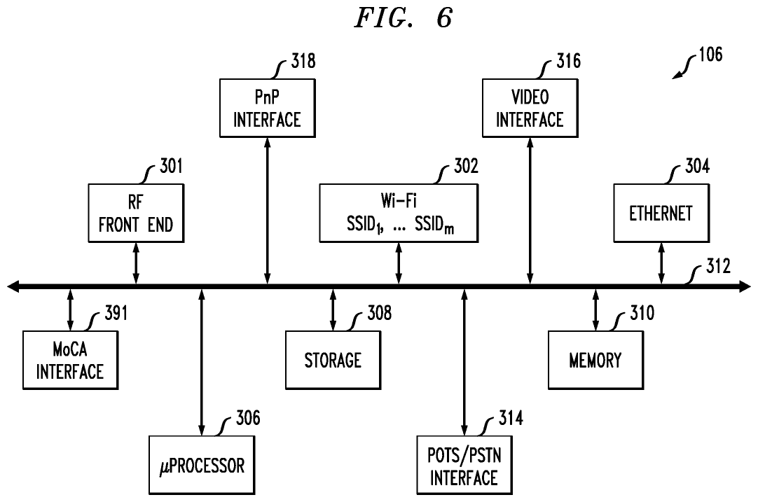

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VOIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0, USB 3.x, USB4) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2/USB 3.x,USB4, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Principles of the present disclosure will be described herein in the context of apparatus, systems, and methods for a network-based backup battery system. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

Generally, methods and systems for a network-based backup battery system are disclosed. In one example embodiment, a battery backup system for a cable modem (CM), service optical network unit (ONU), or the like includes intelligence to dynamically configure the CM, service optical network unit (ONU), or the like in a low-power mode based, for example, on user profiles, traffic patterns and the like. The user profiles and traffic patterns are used, for example, to identify when power is to be conserved, when to test the backup battery system, and the like. In one example embodiment, the integrated battery backup system enables the size of the backup battery to be reduced.

As described above, conventional battery backup devices maintain a fully charged backup battery and switch from the main power to the backup battery when the main power fails (battery backup mode). When the main power is restored, the external battery backup device switches from the backup battery to the main power. In one example embodiment, to minimize thrashing between the main power and the backup battery, the external battery backup device enforces a minimum time duration for staying on battery backup once a switch to the backup battery occurs. In one or more embodiments, the duration is extended each time the main power turns on and off while operating during the minimum duration time period in the backup battery mode.

Exemplary embodiments will now be described in connection with a cable modem and cable modem termination system, it being understood that aspects of the invention are equally applicable to systems employing service optical network units (ONUs) and related components such as access routers 806 and OLTs 812, as described elsewhere herein, or the like. In the battery backup mode, the CM enters a low power mode to extend the battery running time. Note the possibility of (i) a low power mode (to conserve energy) even when there is no power failure and (ii) the PSU failure mode when the PSU fails completely or partially and the system runs on battery power, during which condition a low power mode can also be initiated. In one or more embodiments, low power mode reduces the number of orthogonal frequency-division multiplexing (OFDM), orthogonal frequency-division multiplexing access (OFDMA) and single carrier quadrature amplitude modulation (SC QAM) channels that are in use. The CM sends a message to the CMTS so that the status of the external battery backup device can be monitored via the network. The CM sends, for example, battery status information, including battery charging levels, such that the server 4008 can monitor the backup battery. The message can be sent to an external server or other monitoring device (referred to as the battery monitoring server herein) in addition to or instead of the CMTS.

As noted elsewhere, as used herein, including the claims, a cable modem termination system should be broadly understood to include both legacy iCMTS architectures and DAA (Distributed Access Architecture) systems. In DAA, the combination of a vCMTS and RPD or the combination of a MAC Manager and Remote MACPHY Device (RMD) has the equivalent function of a CMTS. Refer also to the discussion of the vCore/RPD alternative since the vCMTS is a component of the vCore. In the case of the MAC Manager/RMD, the overall system functionality is equivalent, but the location of the MAC function is moved to the RMD.

Consider two concepts pertinent in one or more embodiments: it is desirable to sense the battery to determine battery running time for when the battery is fully charged. Over time, the running time when fully charged will decrease. The pattern of how the running time of a fully charged battery decreases over time is a predictor of battery life, where end of battery life is the point where the battery should be replaced (given the teachings herein, the skilled artisan can heuristically determine a suitable threshold, such as a capacity threshold, for battery replacement by trading off cost of replacement (parts and labor) against negative effects of battery failure.). Some embodiments support multiple low-power modes that can be based on traffic profiles and the current state of the battery, if the service happens to be running on battery backup. It can be beneficial to be in one low-power operating mode with traffic, and then switch to an even lower power operating mode if the battery has discharged to a certain threshold. This concept is in addition to simply putting the modem in a low-power mode when no traffic is flowing (e.g., middle of the night).

The battery monitoring server tracks the battery status and generates notifications to other systems and/or to the user of the CM (such as a cable subscriber). The battery monitoring server can be configured to monitor a plurality of CMs, external battery backup devices, and the like. In one example embodiment, the voltage supplied by the power supply unit (PSU) is monitored, and a solid-state relay or similar switch is used to switch over to the backup battery when the PSU voltage drops below a specified level. In some implementations, different power levels can be distinguished, such as full power, excessive voltage (a voltage greater than the specified operating voltage), partial power (a power level that is insufficient to generate the full operating voltage) and the like. These various power levels may indicate that the PSU or another component needs to be replaced or repaired. For example, if the voltage of the PSU is lower than expected, a modem may train up on a DOCSIS network, but may not be fully functional. The inventor has found that these partial functional states can sometimes be difficult to diagnose.

The battery backup mode is maintained until the monitored PSU voltage surpasses the proper threshold voltage for a specified duration of time (such as the minimum time duration described above) to protect against momentary flickers of power on the main power line. When in the battery backup mode, messages are transmitted to the battery monitoring server indicating that the CM is operating on the backup battery. The battery backup system is also configurable to transmit charging status information to the battery monitoring server. The transmit charging status can be updated when operating in either the main power mode or in the battery backup mode.

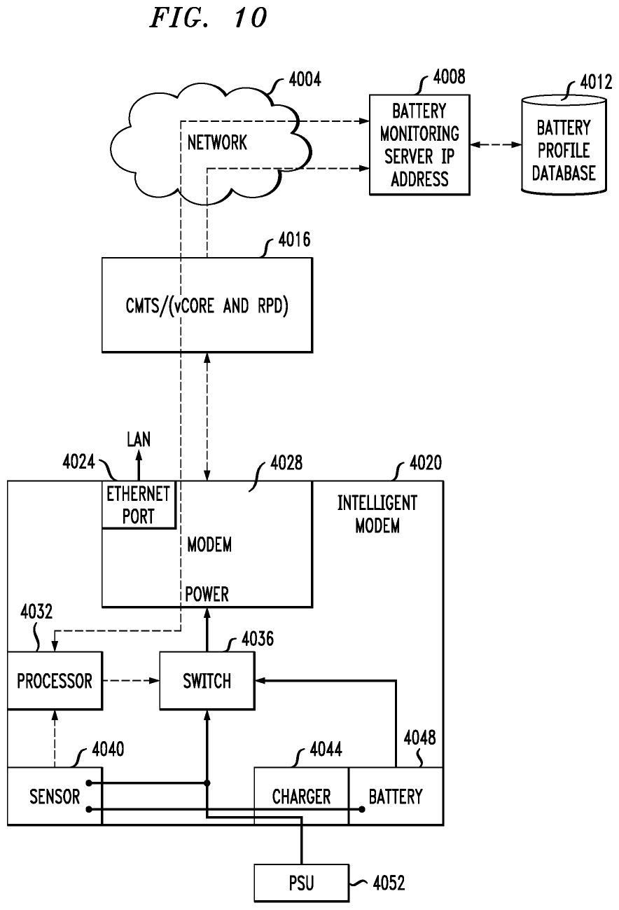

FIG. 10 is a block diagram of a first example (“integrated”) battery backup cable modem system 4020, in accordance with an example embodiment. A power supply unit 4052, which will be familiar to the skilled artisan, provides power to the cable modem 4028 at a higher voltage than the battery 4048 via a processor-controlled switch 4036. The battery is maintained in a charged state by a charger 4044. A sensor 4040 (e.g., digital voltage sensor) monitors the voltage provided by the PSU 4052 and detects whether the modem 4028 is running on main power (from the PSU 4052) or whether the modem 4028 is running on battery power (from the battery 4048) as a result of the voltage provided by the PSU 4052 falling below a given threshold. The processor transmits a power failed message addressed to the battery monitoring server indicating a loss of power. The battery monitoring server signals the CMTS to put the modem in low-power mode. Note that in one or more embodiments, the processor 4032 does the sensing of traffic while the sensor 4040 does the sensing of PSU and battery status.

In one or more embodiments, when the system is powered by PSU 4052, the backup battery 4048 is not connected to power the modem 4028. Sensor 4040 senses both the PSU and the battery voltage levels. When the voltage level of the PSU falls below the voltage level of the battery, the sensor 4040 signals the processor 4032 to flip the switch 4036 to power the modem with the battery. In this aspect, the battery is not really “in parallel,” but rather is switched in when needed. In one or more embodiments, the PSU and battery power the processor 4032 and sensor 4040 so that they will continue to function and operate the switch when the PSU fails. From an implementation perspective, a capacitor can be placed in parallel with the PSU to provide time for the switch to transition to the backup battery to ensure continuous operation. This optional capacitor is omitted from the drawings to avoid clutter.

Some embodiments employ a battery monitoring server 4008 to signal the CMTS to use DOCSIS messages to put the modem 4028 in and out of low-power mode. For example, the server can leverage existing capabilities in the CMTS to adjust the channel and instruct the modem to comply. Other embodiments (which can be generalized to other systems) have a channel assignment function in the CMTS 4016/OLT812/Radio that the server communicates with to reduce channel resources to lower power consumption. The battery sensing aspect can be implemented, for example, over the data plane or the management plane. If over the data plane, such communications could be implemented using the Transmission Control Protocol/Internet Protocol (TCP/IP). CMTS 4016 can be similar, for example, to CMTS 156 described above. Further regarding the CMTS 4016/OLT812/Radio, this component can be generalized as a transceiver function that can be optical (e.g., OLT), copper (e.g., CMTS in a traditional HFC network), or in a wireless scenario (e.g., mobile, Wi-Fi, etc. where the radio has a battery backup). Because the radio can be configured to run with fewer spectrum resources, it can also take advantage of a system to put it in lower power modes depending on the traffic.

When power from the PSU 4052 is restored (e.g., voltage above a predetermined threshold), the sensor 4040 detects that the PSU 4052 is once again providing power and sends a power restored message to the battery monitoring server 4008 via the processor 4032, modem 4028, the CMTS 4016 and network 4004 (which, in a non-limiting example, is an HFC network, but as noted herein, can be a FTTH or FTTC network or many other types of network). In one or more embodiments, sensor 4040 tells the processor 4032 to switch back to PSU power, in addition to sending a power restored message to the server using processor 4032 as just described. The battery monitoring server 4008 instructs the CMTS 4016 to reconfigure the modem 4028 to operate in the normal operating mode (optionally, the server 4008 waits a predetermined time to ensure that power is “really” back to minimize thrashing). In one or more embodiments, switching to battery backup is handled by 4040, 4032, and 4036 and does not involve the CMTS 4016. The exemplary embodiment in FIG. 10 advantageously enables compliance with voluntary requirements to reduce power consumption, such as the VOLUNTARY AGREEMENT FOR ONGOING IMPROVEMENT TO THE ENERGY EFFICIENCY OF SMALL NETWORK EQUIPMENT.

In one example embodiment, the battery monitoring server 4008 is informed of the transmitting and receiving activity of the CM 4028, such as whether the transmit and receive capability of the CM 4028 is functional, whether the CM 4028 transmitted and/or received data, and the like, using a second sensor. Sensing traffic could be, for example, either at the port 4024 or the processor 4032; however, in one or more embodiments, the processor is the component that will take the appropriate action. In one or more embodiments, if sensed at the port 4024, the port advises the processor. A simpler implementation is for the traffic on the port to pass through the processor and the processor to detect traffic, using, e.g., NetFlow or the like. In another aspect, a DPI (Deep Packet Inspection) function can be implemented in the processor. If this is done, then a lower power mode can be engaged depending on the type of traffic. For example, if the traffic is some sort of low bandwidth Internet of things (IoT) traffic, this information can be provided back to the monitoring server, and the monitoring server can invoke a lower power mode (fewer channels) based on profile information relative to that type of traffic.

In another aspect, known deep packet inspection (DPI) techniques can be adapted for use in connection with one or more embodiments. In this aspect, the processor 4032 implements DPI to look for patterns in the traffic and when it recognizes a certain pattern, takes action. Patterns could be search traffic, video, a voice app, or the like. Based on examination of the patterns, DPI techniques can determine what class of service the particular traffic flow is carrying. Once the class of service is determined, it can be inferred how much bandwidth is needed and the number of RF carriers can be reduced or increased as needed.

In one example embodiment, a traffic sensor (not shown as a separate component, can be implemented, for example, at port 4024 or processor 4032 as described just above) monitors the network traffic (such as layer-2 network traffic) transmitted to or received from the network (such as the wide-area network (WAN) portion of the network) by the CM 4028, and the captured traffic monitoring information is sent to a monitoring server, such as the battery monitoring server 4008. For example, the sensor validates that Ethernet is idling by detecting the Idle-pattern as specified in IEEE 802.3. The traffic monitoring information may include when the traffic was sent, the transmission data rate, the source and/or destination of the network traffic and the like. The corresponding usage patterns are used to determine when there is a high probability of no usage or low data usage by the CM 4028 and is used to create profiles that assist in determining when battery testing should be performed, when low power mode and/or normal power mode should be utilized, and the like. One exemplary objective is to learn patterns of activity and inactivity and to, for example, configure the cable modem 4028 in the low power mode when the usage of the CM 4028 is expected to be low.

In embodiments where the battery 4048 is constructed using multiple cells in series, in parallel or both, the cells can be tested individually (for example, in a round-robin fashion) to determine the condition of each cell. The results can be combined to determine the condition of the overall backup battery 4048. By configuring the backup battery such that the cells can be tested individually, the backup battery can also be configured to provide adequate power in backup battery mode (due to a power failure) even while certain cells are being tested. This approach can be made to work in the series case if, for example, there is an extra cell in the series battery. One cell at a time is always switched out of the series of cells so that the resulting voltage does not exceed the normal operating voltage of the series battery. The cell that is switched out can be measured. While the battery is switched out, the remaining cells should be connected in series. A capacitor should be connected in parallel with the series battery pack to smooth out transients from switching cells in and out for testing. Given the teachings herein, the skilled artisan can implement a suitable switch network to switch cells in line, isolate cells for testing, connect voltage or other probes, and the like.

In one example embodiment, the battery monitoring server 4008 can configure parameters that control the behavior of the battery backup cable modem system 4020. Indicators, such as light-emitting diodes (LED), can be used to visually notify a user, such as a technician, of the state of the power system for the CM 4028. In one example embodiment, patterns and sequences of network traffic, battery charge/discharge cycles, and the like are interpreted as conveying various characteristics of battery charge, power state, battery condition, battery type, modem status and the like. Audible alarms, email notifications, web notifications, texts and the like can also be used to convey information, such as battery status information, to the battery monitoring server 4008 or other devices or human users of administrators.

In one example embodiment, the battery monitoring server 4008 develops performance curves for the battery 4048 over time to assess the condition of the battery 4048. For example, information may be logged over time, through charge and discharge cycles, to develop a profile of the battery 4048 for comparison to other types of batteries. The battery monitoring server 4008 generates and maintains a set of profiles for the backup batteries 4048 of the system based on the performance curves. Based on the battery profiles, the battery monitoring server 4008 identifies the type of battery by comparing a battery profile of a given battery 4048 with each of a set of profiles that correspond to known types of batteries (such as known brands, known compositions (e.g., lead-acid, lithium ion, NiMH, etc.), battery age (if known), known models, and the like) and mapping the given battery 4048 to the profile having the closest parameters. In one example embodiment, the backup battery charge/discharge cycles are monitored and machine learning (ML) is used to characterize the backup battery 4048, such as the type of battery, brand of battery, model of battery, life status of the battery and the like.

In some instances, a “smart” battery can have a mechanism where the manufacture date can be read. Otherwise, that information may not be known unless a trusted person manually enters it. In some cases, a sensor can be used record when a battery is installed, and the duration of how long the battery has been installed can be taken into consideration. The profile information can also be used to detect whether someone temporarily removes and reinstalls the same battery, or whether the battery has been replaced with another battery (because the second battery would typically not match the profile of the first battery).

Generally consider the determination of quiescent periods using binning and machine learning. In a binning approach, each day of the week is divided into bins; for example, hourly bins running from midnight to 1 AM, 1 AM to 2 AM, . . . , 11 PM to midnight and a data structure is instantiated with the volume of traffic measured for each bin. Bins with a volume of traffic above a certain threshold are designated for normal operations while bins with a volume of traffic below or equal to a certain threshold are designated for operation in low power mode. The threshold can be determined heuristically by the skilled artisan based on knowledge of the channel capacity of the different available channels. In a machine learning approach to determining quiescent periods, pattern recognition can be employed on the data to identify the quiescent periods. Generally regarding machine learning (ML), in some instances, an ML system, such as a neural network, can be trained on a training data corpus. For example, usage data can be gathered over a period of time for a number of end users, and a human subject matter expert (SME) can label the data with labels such as quiescent time, normal time, or even completely quiescent time, partially quiescent time, normal time, or the like (unsupervised learning could also be employed in some instances to avoid the need for labeling by a human SME). The system is then trained on the annotated data and tested on a held-back portion, and when performance is satisfactory, is deployed to carry out inference on actual data. For example, in the first case, the system switches to a low power mode for quiescent time, and a normal mode for normal time; in the second case, the system switches to a “lower” low power mode for quiescent time, a “higher” low power mode for partially quiescent time, and a normal mode for normal time. ML can be quite pertinent as the granularity of switching is increased between different power modes/levels depending on a variety of parameters that may have interesting interactions and relationships.

In addition to using ML to determine normal and quiescent times, as noted, ML can be used to characterize many other pertinent items, including various parameters related to the backup battery 4048, such as the type of battery, brand of battery, model of battery, life status of the battery and the like. As will be appreciated by the skilled artisan, in each case, data can be gathered for a period of time, labeled by a human expert as to the label of interest (type, brand, model, life status, and the like), tested, and deployed for inference.

The battery monitoring server 4008 also periodically reviews the battery discharge results and estimates the remaining battery life. When the battery life drops below required levels, notifications are sent to, for example, the administrator of the cable modem 4028. Notifications can be sent via email to the customer, via alarms to the service provider and/or to a battery distribution center, and the like. In one example embodiment, the cable modem 4028 and/or the battery 4048 have notification capabilities and can receive and emit notifications. The battery monitoring server 4008 can periodically instruct the processor to deliberately switch off the PSU and run on battery power (so as to assess the battery condition by seeing how rapidly it discharges).

It is noted that the amount of power that a CM 4028 consumes is typically dependent on the bandwidth of the active communication channels (in this context, bandwidth refers to how much of the frequency spectrum is used and not what the data throughput of the channel is). In general, a CM 4028 has a primary channel that is used as the default channel in the low power mode. To minimize power, a narrow OFDM or SC QAM channel can be used as the primary channel and additional channels can be added when, for example, traffic is being transmitted; then, after there has been an absence of traffic for a specified duration (which may change based on time of day, day of the week, or an observed (learned) traffic pattern), the additional channels may be disabled and only the primary channel used. In one example embodiment, if traffic restarts at an unusual time, the cable modem 4028 is put back in full power mode. In some instances, this depends on the status of the battery. For example, if operating in a mode where it is desired to save power, say overnight when a person is sleeping, but the person has insomnia and gets up and wants to stream a movie, this can be detected and the system can go back to full power mode. However, if that fact pattern were to happen when the system was running on battery backup, especially with an “iffy” battery, it is possible that the system would not go back to full power mode. For example, in a simplified embodiment, the status of the battery may not be taken into account. Otherwise, it is possible to take advantage of the state of the battery to extend how long the modem can remain powered. Some embodiments provide an interface to the monitoring server for either the service provider or the subscriber to specify preferences regarding how they would like the battery backup system to behavior in certain situations. Given the teachings herein, to implement one or more embodiments, the skilled artisan could adapt techniques known from laptop battery management options that users can set on a laptop to define processing power vs. battery life behavior.

### Power Saving Profiles

In one example embodiment, the processor 4032 monitors whether user data is being transferred to or from the modem 4028 and reports the results to the battery monitoring server 4008. The battery monitoring server 4008 stores the data in the battery profile database 4012. The battery monitoring server 4008 processes the data in the battery profile database 4012 to determine usage patterns, and stores profiles that capture the usage patterns in the battery profile database 4012. These usage patterns can be used to determine when there is a high probability of no or low data usage. In this aspect, “high” is relative to times when there is more likely to be significant data usage-given the teachings herein, the skilled artisan can heuristically determine threshold values or bins of data usage for when the system is to operate in a normal mode or in one or more low power modes. In this regard, some embodiments can have multiple power modes that, by default, are assigned based on profile thresholds. Then, when user traffic appears and meets the criteria of the profile, the modem exits the current low-power mode either completely or to a low power mode having a higher power level than the current low-power mode, or to a power mode based on preferences defined by the service provider or user in the monitoring server. Regarding “appears and meets the criteria of the profile,” the profile can be flexibly defined by the skilled artisan given the teachings herein; for example, within a particular range, greater than or equal to a threshold, or the like.

To reduce power, the battery monitoring server 4008 selects the profile corresponding to a given modem 4028 and configures the modem 4028 in a low-power mode based on the usage patterns of the profile, as described above. In one example embodiment, the profile includes a start time and a duration.

In one example embodiment, the profile is executed when the modem 4028 is idle. If the modem 4028 is not idle, the execution of the profile is delayed and the profile is executed at a later point in time (consistent with the patterns described in the profile). If the modem 4028 starts passing user traffic while operating in the low power mode, the processor 4032 notifies the battery monitoring server 4008, which in turn instructs the CMTS 4016 to restore the modem 4028 to normal operation, as described above.

### Battery Condition

In one example embodiment, the battery monitoring server 4008 initiates a test of the backup battery 4048 by signaling the processor 4032 via the CM 4028 to switch to battery backup mode (independent of the status of the PSU 4052 and the main power) and monitors how rapidly the backup battery 4048 charges and discharges to assess the condition of the backup battery 4048. The processor 4032 uses the sensor 4040 to monitor the discharge rate of the battery over time, and transmits the results to the battery monitoring server 4008, which stores the results in the battery profile database 4012. As described above, the battery monitoring server 4008 can monitor the transmit and receive status information and perform the backup battery test when the data transmission rate is low. The testing can be performed when the CM 4028 is not actively transmitting data, when the CM 4028 is actively transmitting data and/or when the CM 4028 is switching between an active and inactive transmitting mode; note, however, that while all of the preceding are possible, in one or more embodiments, the best time to test is typically during a quiescent period, especially if the test is on the full battery rather than individual cells. If the battery condition has deteriorated below a given threshold, a notification can be sent to a client device (e.g., smart phone) or other notification system, or an indicator light (e.g., light-emitting diode (LED)) on a modem or router can be activated, to proactively arrange for the replacement or repair of a failing battery.

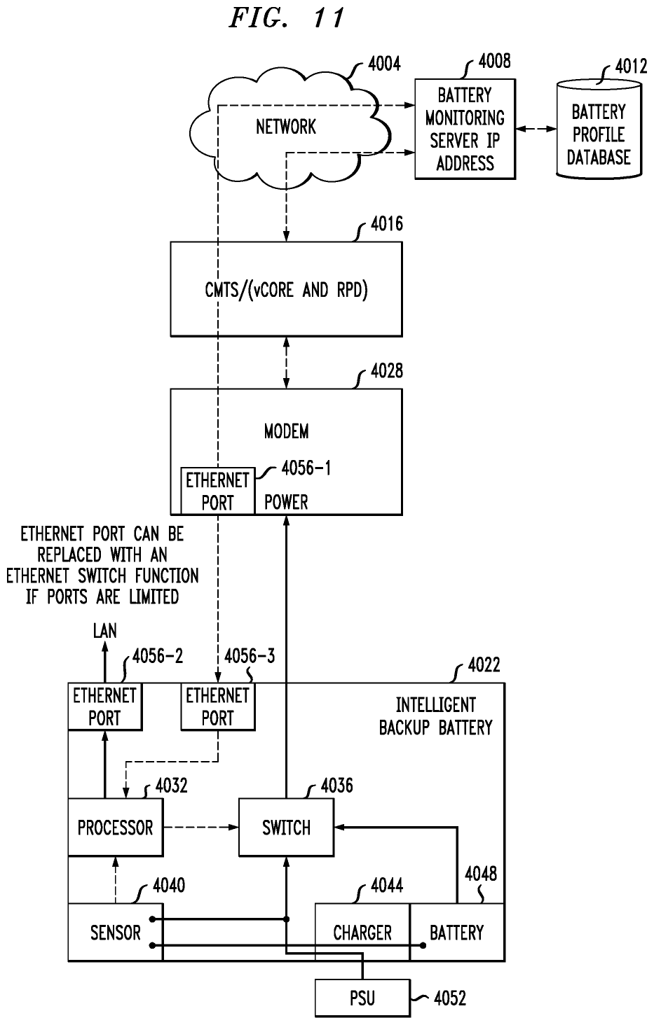

FIG. 11 is a block diagram of a second example (“disaggregated”) battery backup cable modem system 4022, in accordance with an example embodiment. The battery backup cable modem system 4022 with integrated intelligence (e.g., provided by processor 4032, switch 4036, sensor 4040, and related components) enables the backup battery 4048 to work with any network access device, such as CM 4028, that has a communications port such that the system 4022 can communicate with the battery monitoring server 4008 via the network access device. The intelligent system 4022, in conjunction with the battery monitoring server 4008, is able to configure the CM 4028 in a low power mode based, for example, on profiles to conserve power. In one example embodiment, the capabilities of the system 4020, 4022 enable the size of the backup battery 4048 to be reduced. Functions of the battery backup cable modem system 4022 are similar to those described above in conjunction with FIG. 10, but the backup battery 4048 is remote from the modem 4028 (a cable, such as an Ethernet cable, is employed to connect the intelligent system 4022 to the modem 4028). In the example embodiment of FIG. 11, essentially any modem 4028, including legacy modems, can be configured to host a backup battery 4048 by connecting the backup battery system 4022 to the modem 4028 via the Ethernet cable. In one example embodiment, a second Ethernet port 4056-2 is incorporated into the system 4022 as part of an Ethernet switch or hub. This is helpful to avoid reducing the number of Ethernet ports available for use by a user for the user's LAN (some modems may only have one Ethernet port). It should also be noted that in one or more embodiments, an Ethernet port can be replaced with an Ethernet switch (or Ethernet hub) function if the number of ports is limited; the switch then manages the flow of data to other devices in lieu of using multiple ports.

In one or more embodiments, the battery backup cable modem system 4022 is provided with a communication channel to the battery monitoring server 4008. The communications channel can be implemented, for example, using an Ethernet port 4056-3. Cabling connects the Ethernet port 4056-3 of the battery backup cable modem system 4022 to an Ethernet port 4056-1 on the CM 4028. The battery backup cable modem system 4022 contains the threshold and switching components, and the intelligence and control provided by the processor 4032 and sensors (e.g., sensor 4040 and a traffic sensor in port 4056-2 or processor 4032 similar to that described with regard to FIG. 10). To detect the presence or absence of traffic, an additional or shared port can be used to route traffic to the traffic detection mechanism in the battery backup cable modem system 4022 and on to the LAN port 4056-2. Return traffic from the LAN is routed from 4056-2 through 4056-3 back to 4056-1. Signaling required to put the CM 4028 into low power mode can be initiated by the battery monitoring server 4008 in communication with the CMTS 4016 which in turn communicates with the CM 4028 to put the CM 4028 into low power mode. For the avoidance of doubt, in one or more embodiments, the battery backup mode is entered based on sensor 4040 as described elsewhere herein.

Elements in the embodiments of FIG. 11 that have the same number as elements in FIG. 10, and are not separately discussed, can operate in a manner similar to those elements in FIG. 10. Thus, functions in FIG. 11 can be the same as those in FIG. 10 but allowing the battery to be remote from the modem and only requiring an Ethernet cable to connect the intelligent battery to the modem. Advantageously, any modem can host a backup battery by connecting the intelligent backup battery to the modem via an Ethernet cable.

One or more embodiments thus learn, create, and or monitor modem traffic profiles and/or learn traffic profiles to minimize power consumption, and use learned traffic profiles to minimize customer impact of battery testing (e.g., do battery testing at night when usage is zero or low). One or more embodiments learn, create, and/or use battery discharge curves to proactively notify and dispatch a technician for battery replacement. One or more embodiments remotely detect battery types and/or models by creating discharge curves and comparing them to known profiles. One or more embodiments provide a centralized ability to monitor backup batteries through diverse cable systems.

### Power Over Ethernet (POE)

The skilled artisan will be familiar with the prior art Power over Ethernet (POE) system, as known, for example, from IEEE Std 802.3-2022, IEEE Standard for Ethernet Section Two, Section 33, IEEE 2022, pages 1311-1336, hereby expressly incorporated by reference herein for all purposes. The PoE system provides for the transmission of power over Ethernet cabling and conforms to the 10GBASE-T standard where all the pairs of wires are used for data and/or power. Transformers are used to couple power onto and off the data pairs of the Ethernet cable. In PoE, the power sourcing equipment (PSE) and the powered device (PD) use DC-to-DC converters to increase the voltages to high levels to allow for the transmission of power over long distances (up to 100 meters (M)). It is worth noting that there are older versions of POE that use 2 of the 4 pairs for power, and older versions of Ethernet that use the other 2 of the 4 pairs for the transmission of Ethernet data. A non-limiting exemplary embodiment illustrates application to Ethernet versions that use all 4 pairs for data transmission as in the case of 10GBASE-T. However, various embodiments can also be used by applying the 12V power to 1 or 2 pairs of the CAT5 cable that are not used for the transmission of Ethernet data. When this is the case, transformers are not needed to separate the Ethernet data streams from the DC power. Generally, the skilled artisan will be able to apply aspects of the invention to other combinations of different versions of Ethernet and PoE.

While PoE could be used in one or more embodiments, one or more exemplary embodiments transmit power over Ethernet but in a manner different than the prior art PoE System. In one or more exemplary embodiments, while DC-to-DC converters could be used, they are not needed due to the relatively short distance over which power is to be transmitted. Thus, in one or more exemplary embodiments, DC-to-DC converters are not used and the Ethernet cable over which the power is to be transmitted is limited to a length of 10 meters (m), or 5 m, or 4 m, or 3 m. Furthermore in this regard, in a non-limiting example, assuming that the modem requires 18 W of power, and that a drop of no more than 1V is to be permitted across the Ethernet cable, and given that the DC resistance of CAT5 cabling is about 0.188 Ohms/m, the maximum distance can be calculated as [1V/(18 W/12V)]/0.188 Ohms/m=3.55 m or 11.6 feet. Some current modems are specified to operate on as little as 8.5V. In an example targeting 9V, up to a 3 V drop could be tolerated in the Ethernet cable corresponding to 3×3.55 m of length or about 10 m. The more power the device needs, the shorter the Ethernet cable will need to be. ONUs will typically use less power than cable modems. Wi-Fi routers will typically use more power than cable modems. In another non-limiting example, for a Wi-Fi router that consumes 36 W, the maximum length of CAT5 cabling would be about 5 m. The skilled artisan will recognize that other types of CAT cabling can be used (e.g., CAT 5e, CAT 6, etc.). The use of CAT 5 as discussed here is by way of a non-limiting example.

In one or more embodiments, on the power supply side, all that is needed is a power source, such as a power supply unit 4052 or battery 4048, capable of providing the nominal DC voltage (such as 12 V) that is required by the modem 4028 (other voltages can be used where required).

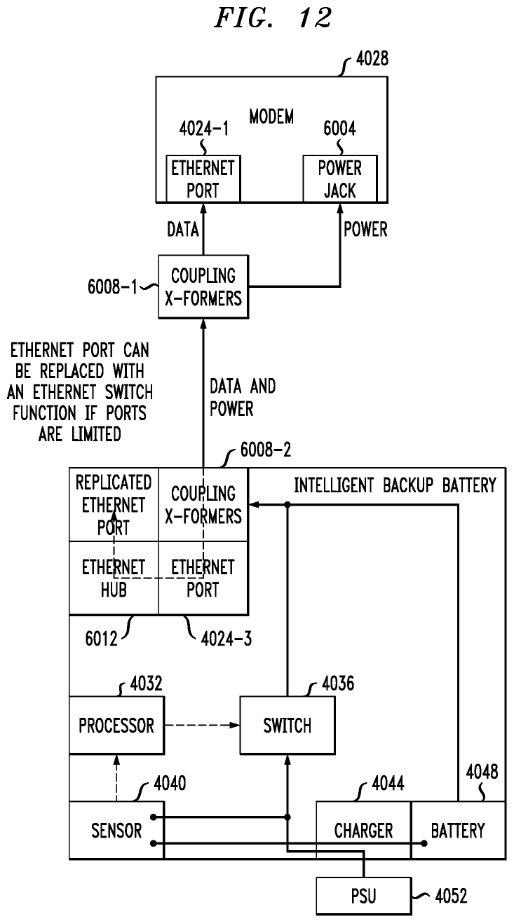

FIG. 12 is a block diagram of a third example battery backup cable modem system that incorporates a system that sends power over Ethernet cabling, in accordance with an example embodiment, but which differs in some pertinent respects from the prior-art PoE system, as will be described herein. In the example embodiment, an external coupling transformer 6008-1 terminates the Ethernet cable for legacy devices that do not have an internal transformer coupled to the Ethernet port 4024-1, and passes the data through to the Ethernet port 4024-1 of the legacy device, splits the DC power out and couples it into the input power jack 6004 of the cable modem 4028. Note the internal coupling transformer 6008-2 associated with port 4024-3. Ethernet port 4024-1 is analogous to Ethernet port 4056-1 in FIG. 11; Ethernet port 4024-3 is analogous to Ethernet port 4056-3 in FIG. 11; and Ethernet hub 6012 (or switch) with corresponding replicated Ethernet port is analogous to Ethernet port 4056-2 in FIG. 11.

Note that in the prior-art PoE system, the DC voltage is applied to the output of a transformer, so it does not actually pass through a transformer. The DC is carried across just as if it was carried across over a regular wire. On the other end, the DC powers the powered device before the transformer. Only the non-DC part of the transmission (Ethernet) passes through the transformers. The transformers 6008-1, 6008-2 in the depicted embodiments can function similarly.

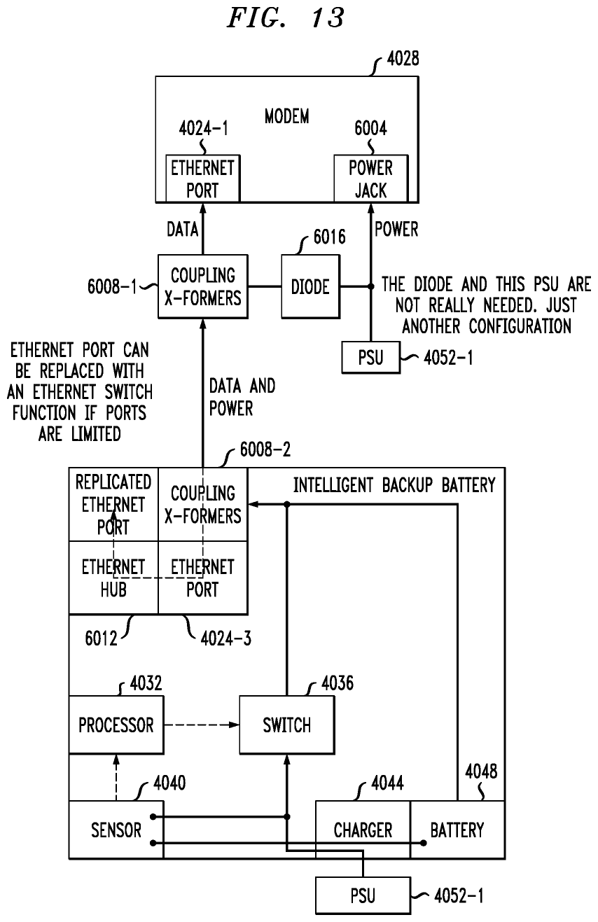

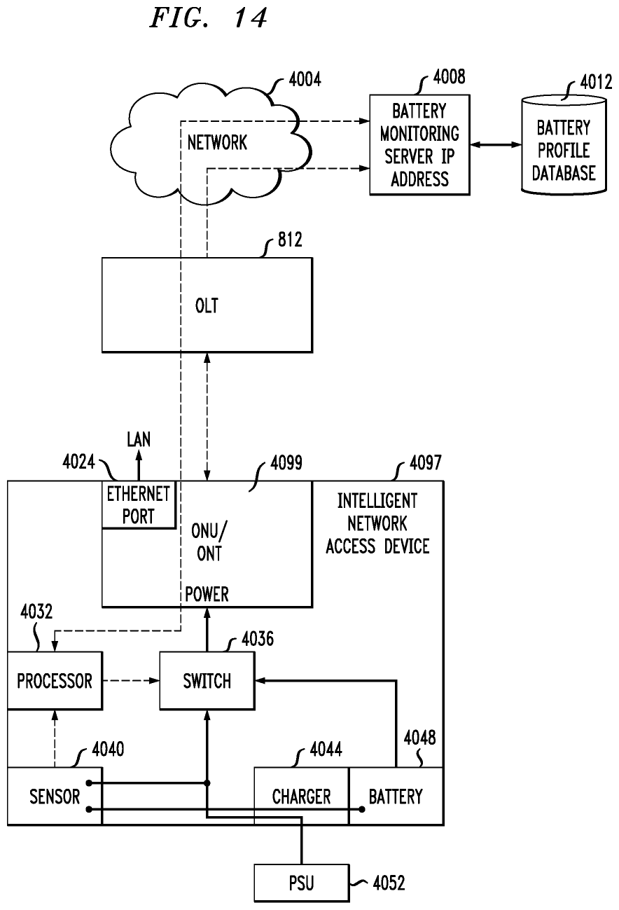

FIG. 13 is a block diagram of a fourth example battery backup cable modem system that incorporates a system that sends power over Ethernet (POE) cabling, in accordance with an example embodiment, but which differs in some pertinent respects from the prior-art PoE system, as will be described herein. The PSU analogous to PSU 4052 in FIG. 12 is renumbered as 4052-1. In the example embodiment of FIG. 14, a blocking diode 6016 is incorporated between the external coupling transformer 6008-1 and the input power jack 6004 to keep the power supply unit 4052-1 from back-feeding power into the Ethernet cable when the PSU 4052-1 is providing power to the cable modem 4028 (note that PSU 4052-1 at the bottom of FIG. 13 is also providing power into jack 6004 (i.e., there is only one PSU in the example, and it provides power to both the battery backup system and the modem)). The blocking diode circuit is set to switch from: (i) a condition where the PSU 4052-1 is providing power to (ii) a condition where the Ethernet cable is providing power, at a pre-determined voltage level (e.g., 10.5 VDC). Blocking diodes 6016 are known in automotive applications where there is more than one battery, as in a vehicle pulling a trailer with a separate battery for the trailer, which is connected in such a way that it can be charged by the vehicle's alternator while the vehicle is towing the trailer. Blocking diodes 6016 are also known in systems with solar panels and batteries to ensure that the battery/batteries do/does not discharge through the solar panel at night. It is noted that in one or more embodiments, unlike the IEEE Std 802.3-2022 33. Power over Ethernet over 2 Pairs, PSE detection of PDs is not needed (the blocking diode is sufficient) and the functions in IEEE Std 802.3-2022 are not required because there is no need to control the voltages between the PSE and PD since the distance is short (see discussion of exemplary cable lengths elsewhere herein) and the operating voltage is fixed (it is appropriate in one or more embodiments to control the length of the Ethernet cable to ensure that the voltage drop across the cable is not excessive for the amount of power that is needed to power the device). In addition, PSE classification of PDs and mutual identification is not needed in one or more embodiments, since there is no need to identify device type (there is only a single type).

Functioning and implementation of the processor 4032: as will be appreciated by the skilled artisan given the teachings herein, the functions of processor 4032 can be implemented with a general purpose processor with appropriate firmware and/or software, or using an ASIC or FPGA. Given the teachings herein, the processor 4032 can be configured by the skilled person, using programming or the like, to implement appropriate functionality such as: traffic sensing (e.g., using tools like NetFlow or the like); transmitting a power failed message addressed to the server 4008 indicating a loss of power; reporting to the server 4008 whether there is traffic; switching to battery backup mode responsive to a signal from server 4008 (e.g., for test purposes); monitoring battery performance during a test and reporting same back to the server 4008; providing intelligence, control, and sensor interface as described herein; and the like.

RPD/vCore alternative: Another non-limiting exemplary aspect will now be discussed (note that the vCMTS is a component of the vCore). In this regard, MAC and PHY layers are concepts familiar to the ordinary skilled worker; generally, the MAC layer controls the timing of signals to be sent from or received by equipment, while the PHY layer generates or receives the actual signals on the physical connection. The skilled artisan will also be familiar with the Converged Cable Access Platform (CCAP), the concept of a remote physical device (RPD), and with the existing “Remote-Phy” standards, including Data-Over-Cable Service Interface Specifications DCA-MHAv2, Modular Headend Architecture v2 Technical Report, CM-TR-MHAv2-V01-150615, Cable Television Laboratories, Inc. 2014-2015, Jun. 15, 2015, and Data-Over-Cable Service Interface Specifications DCA, Distributed CCAP Architectures Overview Technical Report, CM-TR-DCA-V01-150908, Cable Television Laboratories, Inc. 2015, Sep. 8, 2015, both of which are hereby expressly incorporated herein by reference in their entireties for all purposes. The Remote PHY technology allows for an integrated CCAP to be separated into two components: the CCAP Core and the Remote PHY Device (RPD). One of the common locations for an RPD is the optical node device that is located at the junction of the fiber and coax plants, while the CCAP Core stays at the headend. A CCAP core can control and setup data paths with multiple RPDs situated in multiple fiber nodes. The Remote PHY technology uses pseudowires between a CCAP Core and a set of RPDs. The CCAP Core contains both a CMTS Core for supporting DOCSIS data transport and an Edge QAM Core for supporting video transport. The CMTS Core contains the DOCSIS MAC (signaling functions, downstream and upstream bandwidth scheduling, and DOCSIS framing) and the upper layer protocols. Remote PHY supports both DOCSIS 3.0, 3.1 & 4.0 Specifications. The EQAM Core contains known video processing functions. The skilled artisan will also be familiar with the virtual core (vCore) concept. As will be appreciated by the skilled artisan given the teachings herein, embodiments of the invention can utilize RPD/vCore functionality.

Given the discussion thus far, it will be appreciated that, in general terms, an exemplary method, according to an aspect of the invention, includes the step of obtaining, at a monitoring server of a network (e.g., 4008), usage data from a plurality of traffic sensors associated with a plurality of devices of interest (e.g., 4028 or equivalent devices in FTTC or FTTC networks) of a plurality of network users. In a non-limiting example, the network is a hybrid fiber-coaxial network; however, other kinds of networks are also possible. Some embodiments can employ any type of service network delivered over DOCSIS. Indeed, the type of network can also be generalized to any wired, fibered, or wireless network where there is a backup battery, at a device of interest, to be monitored.

A further step includes, based on the obtained usage data, creating a plurality of traffic profiles for the plurality of devices of interest of the plurality of network users. This can be done, for example, by a server such as server 4008 creating profiles based on a binning procedure, applying a machine learning procedure, or the like. The profiles can be stored in a database associated with the server. A still further step includes, from time to time, causing first signals to be sent, based on the plurality of traffic profiles, to the plurality of devices of interest. The first signals cause the plurality of devices of interest to enter a low power mode during first times (e.g., relatively quiescent times). An even further step includes, from time to time, causing second signals to be sent, based on the plurality of traffic profiles, to the plurality of devices of interest (e.g., relatively busy times). The second signals cause the plurality of devices of interest to leave the low power mode for a normal power mode during second times.

In at least some cases, the low power mode uses fewer spectrum resources than are used in the normal power mode. In a non-limiting example, the low power mode consists of use of only a single channel and the normal power mode includes use of at least two channels. However, many different approaches are possible. For example, the low power mode can use one less channel than the normal power mode, or one less channel than the current mode in the case that there are multiple modes. Alternatively, rather than one less channel, a narrower channel can be used in the lower power mode than in the normal mode or a narrower channel than in the current mode (where there are more than two modes). The fewer the spectrum resources used, the lower the power required.

In one or more embodiments, creating the plurality of traffic profiles for the plurality of devices of interest of the plurality of network users includes identifying the first times as less busy than the second times.

One or more instances further include, from time to time, causing third signals to be sent, based on the plurality of traffic profiles, to the plurality of devices of interest. The third signals causing a plurality of backup batteries to be tested during the first times to determine corresponding battery states. The plurality of backup batteries are associated with the plurality of devices of interest. At least some such instances further include, from time to time, causing fourth signals to be sent, based on the backup battery testing. The fourth signals cause replacement to be initiated for a failing subset of the plurality of backup batteries. In this context, failing means a decrease in capacity, such that assessment of the decrease determines the extent to which the battery (ies) are failing-given the teachings herein, the skilled artisan can heuristically determine a suitable capacity threshold for replacement by trading off cost of replacement (parts and labor) against negative effects of battery failure.

In a non-limiting example, the network is a hybrid fiber-coaxial network; the devices of interest are cable modems; and the first and second signals are sent via at least one cable modem termination system of the hybrid fiber-coaxial network. As noted, other implementations are possible, such as where the devices of interest are S-ONUs or the like in a fiber network.

As used herein, including the claims, a cable modem termination system should be understood to cover both a legacy cable modem termination system and a virtualized cable modem termination system (vCMTS) as used in the DOCSIS DAA (Distributed Access Architecture) system.

One or more embodiments further include obtaining, at the monitoring server of the network, an indication of a power failure at one of the plurality of devices of interest; and, responsive to obtaining the indication of the power failure, the monitoring server of the network causing a fifth signal to be sent, the fifth signal causing the one of the plurality of devices of interest having the indicated power failure to enter another low power mode (which can be the same or different as the first mentioned low power mode; see discussion of multiple low power modes, intermediate mode(s) elsewhere herein). In this aspect, the power failure will typically result in the device entering the battery backup mode, such as due to a failure of the commercial electric power utility. As noted, in another aspect, battery backup mode is periodically deliberately entered even when commercial power is available.

One or more embodiments further include, from time to time, causing sixth signals to be sent, based on the plurality of traffic profiles, to the plurality of devices of interest. The sixth signals cause the plurality of devices of interest to enter an intermediate power mode during third times, wherein the intermediate power mode uses fewer spectrum resources than are used in the normal power mode and more spectrum resources than are used in the low power mode. The intermediate more can also be thought of as a “higher” low power mode and the corresponding “regular” low power mode as a “lower” low power mode.

Some instances further include obtaining, at the monitoring server of the network, an indication of a partial power failure at one of the plurality of devices of interest—the partial power failure in this aspect is a non-zero but out of specification voltage (e.g., 6 V rather than in-spec 12 V). Responsive to obtaining the indication of the partial power failure, the monitoring server of the network causes a seventh signal to be sent. The seventh signal causes at least a component replacement to be initiated for the one of the plurality of devices of interest (e.g., send a text or email to owner and/or maintenance department and/or cause an indicator light on the equipment to turn on, blink, etc.).

Note that designations such as “first,” “second,” “third,” “fourth,” “fifth,” “sixth,” and “seventh” of the like are used for terminological convenience. A claim that recites, for example, a “seventh” signal does not necessarily imply that the claim requires six other signals.

In another aspect, another exemplary method includes providing, to a monitoring server of a network (e.g., 4008), usage data from a traffic sensor associated with a device of interest (e.g., 4028 or equivalent devices in FTTC or FTTH networks) of a network user. In a non-limiting example, the network is a hybrid fiber-coaxial network; however, other kinds of networks are also possible. Some embodiments can employ any type of service network delivered over DOCSIS. Indeed, the type of network can also be generalized to any wired, fibered, or wireless network where there is a backup battery at a device of interest.

A further step includes, from time to time, obtaining at least a first signal from the monitoring server of the network. The at least first signal causes the cable modem to enter a low power mode during at least a first time, based on a traffic profile created for the device of interest using the usage data. A still further step includes, from time to time, obtaining at least a second signal from the monitoring server of the network. The at least second signal causes the device of interest to leave the low power mode for a higher power mode (relative to the low power mode) during at least a second time, based on the traffic profile. The higher power mode can be, for example, normal power or a (previous) “higher” low-power mode or intermediate mode. If there are multiple power modes, the traffic profile can be used to determine which power mode to enter after leaving the current low power mode.

In at least some instances, the low power mode uses fewer spectrum resources than are used for the higher power mode. In a non-limiting example, the low power mode consists of use of only a single channel and the higher power mode includes use of at least two channels. However, many different approaches are possible. For example, the low power mode can use one less channel than the higher power mode, or one less channel than the current mode in the case that there are multiple modes. Alternatively, rather than one less channel, a narrower channel can be used in the lower power mode than in the higher mode or a narrower channel than in the current mode (where there are more than two modes). The fewer the spectrum resources used, the lower the power required.

In some cases, in the steps of obtaining the at least first and second signals, the first times are projected by the monitoring server as less busy than the second times.

One or more embodiments further include, from time to time, obtaining at least a third signal. The at least third signal causes a backup battery associated with the device of interest to be tested during the at least first time. At least some such cases further include obtaining a fourth signal. The fourth signal causes replacement of the backup battery to be initiated, based on failure of the testing, as discussed elsewhere herein. For example, a user or technician can replace the battery.

In a non-limiting example, the network is a hybrid fiber-coaxial network; the devices of interest are cable modems; and the first and second signals are obtained via a cable modem termination system of the hybrid fiber-coaxial network.

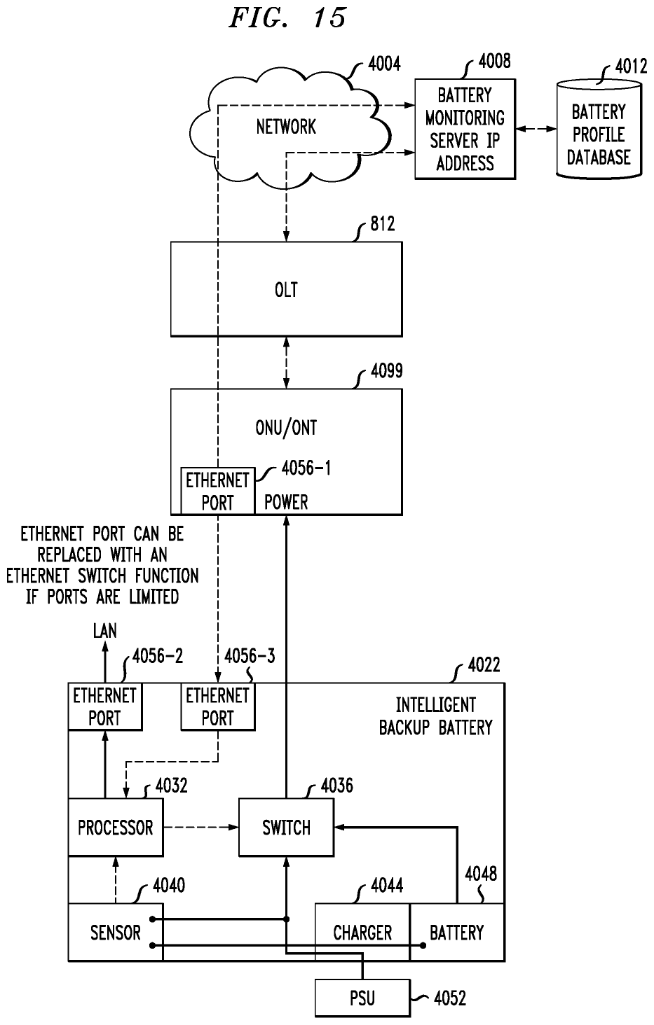

As noted, other implementations are possible, such as where the devices of interest are S-ONUs or the like in a fiber network. Furthermore in this regard, FIGS. 14 and 15 show fiber analogs of the systems of FIGS. 10 and 11, respectively. In the exemplary fiber implementations of FIGS. 14 and 15, the CMTS becomes OLT 812; the modem 4028 becomes the ONU (such as S-ONU 822) or ONT (Optical Network Terminal) (telecon equivalent of ONU); generally, ONU/ONT 4099. The intelligent modem 4020 becomes intelligent network access device 4097. The remaining components in FIGS. 14 and 15, including the Ethernet ports, are analogous to the corresponding components in FIGS. 10 and 11. While an exemplary FTTH system is depicted, similar considerations apply to an FTTC system. In particular, for FTTC, a connection between the curb and house could be copper instead of fiber, and the ONU/ONT can be at the curb instead of in the premises, assuming it is powered locally at the curb. If the ONU/ONT at the curb is powered from the premises, the integrated case of FIG. 14 would not necessarily be applicable but the configuration of FIG. 15 could be employed.

Thus, in another non-limiting example, the network is a fiber network; the devices of interest comprise at least one of optical network units and optical network terminals; and the first and second signals are obtained via an optical line terminal of the fiber network.

Some embodiments further include obtaining an indication of a power failure at the device of interest, and, responsive to obtaining the indication of the power failure: the device of interest entering a battery backup mode; the device of interest advising the monitoring server of the power failure; and the device of interest entering another low power mode (which can in general be the same or different than the previously recited low power mode) responsive to a fifth signal caused to be sent by the monitoring server based on the monitoring server being advised of the power failure.

As seen in FIG. 10, in some cases, the battery backup mode includes obtaining power from a battery integrated with the device of interest. On the other hand, as seen in FIGS. 11-13, in other instances, the battery backup mode includes obtaining power from an external battery.

One or more embodiments include obtaining power from the external battery over an Ethernet cable; as noted, in one or more embodiments, in a different manner than the prior-art PoE system. In some instances, the Ethernet cable has a length no more than 10 meters; in some cases, at a voltage of no more than 12 volts; in some cases, without the use of DC-to-DC converters.

In one or more embodiments, the traffic sensor is implemented using at least one processor, and a further step includes carrying out deep packet inspection (DPI) with the at least one processor (e.g., processor 4032, processor of the monitoring server, other processor, combinations of the preceding). Thus, in another aspect, known DPI techniques can be adapted for use in connection with one or more embodiments. In this aspect, one or more processors implement DPI to look for patterns in the traffic and when a certain pattern is recognized, appropriate action is taken.

As noted, different power levels can be distinguished, such as full power, excessive voltage (a voltage greater than the specified operating voltage is provided by the PSU), partial power (a power level that is insufficient to generate the full operating voltage is supplied by the PSU) and the like. These various power levels may indicate that the PSU or another component needs to be replaced or repaired. For example, if the voltage of the PSU is lower than expected, a modem may train up on a DOCSIS network, but may not be fully functional, as discussed elsewhere.

Again, while examples are shown for a cable modem and CMTS, embodiments are applicable in many contexts such as RPD/vCore, fiber system with access router, OLT, and S-ONU, etc.

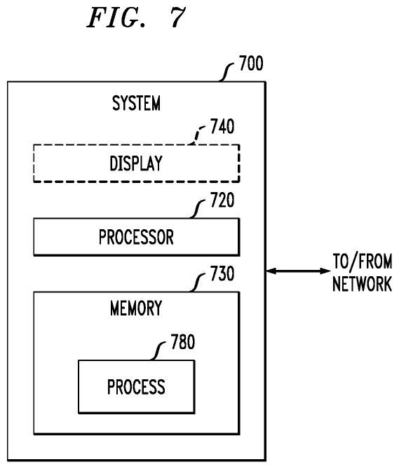

In another aspect, a monitoring server 4008 of a network is provided. The monitoring server includes: a memory 730; and at least one processor 720, coupled to the memory, and operative to carry out or otherwise facilitate any one, some, or all of the method steps herein. See FIG. 7.

In still another aspect, a non-transitory computer readable medium includes computer executable instructions which when executed by a computer (e.g., a monitoring server) cause the computer to perform a method including carrying out or otherwise facilitating any one, some, or all of the method steps herein.

In yet a further aspect, an exemplary apparatus includes a cable modem 4028; a switch 4036; a power supply unit port selectively coupled to the cable modem through the switch (known plug or port to attach to the PSU 4052); a battery 4048 selectively coupled to the cable modem through the switch; a processor 4032 coupled to the switch and the cable modem; and a sensor 4040 coupled to the power supply unit port and the battery and configured to sense a power supply unit failure condition. The processor is configured to implement a traffic sensor (e.g., NetFlow as discussed) and provide, to a monitoring server 4008 of a network to which the apparatus is coupled, usage data from the traffic sensor. The cable modem is configured to: from time to time, obtain at least a first signal from the monitoring server of the network, the at least first signal causing the cable modem to enter a low power mode during at least a first time, based on a traffic profile created for the device of interest using the usage data; and from time to time, obtain at least a second signal from the monitoring server of the network, the at least second signal causing the cable modem to leave the low power mode for a higher power mode during at least a second time, based on the traffic profile.

In some cases, the processor is further configured to: obtain from the sensor an indication of the power supply unit failure condition; and responsive to obtaining the indication of the power supply unit failure condition: cause the switch to switch from connecting the power supply unit port to the modem to connecting the battery to the modem; and advise the monitoring server of the power supply unit failure condition. The cable modem is further configured to enter another low power mode responsive to a fifth signal caused to be sent by the monitoring server based on the monitoring server being advised of the power supply unit failure condition.

In some cases, the cable modem, the switch, the power supply unit port, the battery, the processor, and the sensor are implemented as a single unit (e.g., within a single housing). See FIG. 10. On the other hand, in some cases, the cable modem is implemented as a first unit, and the switch, the power supply unit port, the battery, the processor, and the sensor are implemented as a separate second unit coupled to the first unit with an Ethernet cable. See FIGS. 11-13. The units can each have their own housings, for example. The outline(s) of the units in the figures schematically represent the housing(s).

Also, the power supply unit port can be external (to couple to an external PSU as shown) but could also be internal (coupling to an integrated internals PSU).

In one or more embodiments, the first unit and the second unit are cooperatively configured for the second unit to at least partially power the first unit over the Ethernet cable. See FIGS. 12 and 13.

### System and Article of Manufacture Details

Different aspects of the invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an application-specific integrated circuit (ASIC) or field-programmable gate array (FPGA) rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
obtaining, at a monitoring server of a network, usage data from a plurality of traffic sensors associated with a plurality of devices of interest of a plurality of network users;
based on the obtained usage data, creating a plurality of traffic profiles for the plurality of devices of interest of the plurality of network users;
from time to time, causing first signals to be sent, based on the plurality of traffic profiles, to the plurality of devices of interest, the first signals causing the plurality of devices of interest to enter a low power mode during first times; and
from time to time, causing second signals to be sent, based on the plurality of traffic profiles, to the plurality of devices of interest, the second signals causing the plurality of devices of interest to leave the low power mode for a normal power mode during second times.

2. The method of claim 1, wherein the low power mode uses fewer spectrum resources than are used in the normal power mode.

3. The method of claim 2, wherein the low power mode consists of use of only a single channel and the normal power mode comprises use of at least two channels.

4. The method of claim 2, wherein creating the plurality of traffic profiles comprises applying a binning procedure.

5. The method of claim 2, wherein creating the plurality of traffic profiles comprises applying a machine learning procedure.

6. The method of claim 2, wherein creating the plurality of traffic profiles for the plurality of devices of interest of the plurality of network users comprises identifying the first times as less busy than the second times.

7. The method of claim 2, further comprising from time to time, causing third signals to be sent, based on the plurality of traffic profiles, to the plurality of devices of interest, the third signals causing a plurality of backup batteries to be tested during the first times to determine corresponding battery states, the plurality of backup batteries being associated with the plurality of devices of interest.

8. The method of claim 7, further comprising from time to time, causing fourth signals to be sent, based on the backup battery testing, the fourth signals causing replacement to be initiated for a failing subset of the plurality of backup batteries.

9. The method of claim 2, wherein:
the network comprises a hybrid fiber-coaxial network;
the devices of interest comprise cable modems; and
the first and second signals are sent via at least one cable modem termination system of the hybrid fiber-coaxial network.

10. The method of claim 2, further comprising:
obtaining, at the monitoring server of the network, an indication of a power failure at one of the plurality of devices of interest; and
responsive to obtaining the indication of the power failure, the monitoring server of the network causing a fifth signal to be sent, the fifth signal causing the one of the plurality of devices of interest having the indicated power failure to enter another low power mode.

11. The method of claim 2, further comprising, from time to time, causing sixth signals to be sent, based on the plurality of traffic profiles, to the plurality of devices of interest, the sixth signals causing the plurality of devices of interest to enter an intermediate power mode during third times, wherein the intermediate power mode uses fewer spectrum resources than are used in the normal power mode and more spectrum resources than are used in the low power mode.

12. The method of claim 2, further comprising:
obtaining, at the monitoring server of the network, an indication of a partial power failure at one of the plurality of devices of interest, the partial power failure comprising a non-zero but out of specification voltage; and
responsive to obtaining the indication of the partial power failure, the monitoring server of the network causing a seventh signal to be sent, the seventh signal causing at least a component replacement to be initiated for the one of the plurality of devices of interest.

13. A method comprising:
providing, to a monitoring server of a network, usage data from a traffic sensor associated with a device of interest of a network user;
from time to time, obtaining at least a first signal from the monitoring server of the network, the at least first signal causing the cable modem to enter a low power mode during at least a first time, based on a traffic profile created for the device of interest using the usage data; and
from time to time, obtaining at least a second signal from the monitoring server of the network, the at least second signal causing the device of interest to leave the low power mode for a higher power mode during at least a second time, based on the traffic profile.

14. The method of claim 13, wherein the low power mode uses fewer spectrum resources than are used for the higher power mode.

15. The method of claim 14, wherein the low power mode consists of use of only a single channel and the higher power mode comprises use of at least two channels.

16. The method of claim 14, wherein, in the steps of obtaining the at least first and second signals, the first times are projected by the monitoring server as less busy than the second times.

17. The method of claim 14, further comprising from time to time, obtaining at least a third signal, the at least third signal causing a backup battery associated with the device of interest to be tested during the at least first time.

18. The method of claim 17, further comprising obtaining a fourth signal, the fourth signal causing replacement of the backup battery to be initiated, based on failure of the testing.

19. The method of claim 14, wherein:
the network comprises a hybrid fiber-coaxial network;
the devices of interest comprise cable modems; and
the first and second signals are obtained via a cable modem termination system of the hybrid fiber-coaxial network.

20. The method of claim 14, wherein:
the network comprises a fiber network;
the devices of interest comprise at least one of optical network units and optical network terminals; and
the first and second signals are obtained via an optical line terminal of the fiber network.

21. The method of claim 14, further comprising:
obtaining an indication of a power failure at the device of interest; and
responsive to obtaining the indication of the power failure:
the device of interest entering a battery backup mode;
the device of interest advising the monitoring server of the power failure; and
the device of interest entering another low power mode responsive to a fifth signal caused to be sent by the monitoring server based on the monitoring server being advised of the power failure.

22. The method of claim 21, wherein the battery backup mode comprises obtaining power from a battery integrated with the device of interest.

23. The method of claim 22, wherein the battery backup mode comprises obtaining power from an external battery.

24. The method of claim 23, wherein the battery backup mode comprises obtaining power from the external battery over an Ethernet cable having a length no more than 10 meters.

25. The method of claim 24, wherein the battery backup mode comprises obtaining power from the external battery over the Ethernet cable having the length no more than 10 meters at a voltage of no more than 12 volts.

26. The method of claim 25, wherein the battery backup mode comprises obtaining power from the external battery over the Ethernet cable having the length no more than 10 meters at the voltage of no more than 12 volts, without the use of DC-to-DC converters.

27. The method of claim 13, wherein the traffic sensor is implemented using at least one processor, further comprising carrying out deep packet inspection with the at least one processor.

28. A non-transitory computer readable medium comprising computer executable instructions which when executed by a computer cause the computer to perform a method comprising the steps of:
obtaining, at a monitoring server of a network, usage data from a plurality of traffic sensors associated with a plurality of devices of interest of a plurality of network users;
based on the obtained usage data, creating a plurality of traffic profiles for the plurality of devices of interest of the plurality of network users;
from time to time, causing first signals to be sent, based on the plurality of traffic profiles, to the plurality of devices of interest, the first signals causing the plurality of devices of interest to enter a low power mode during first times; and
from time to time, causing second signals to be sent, based on the plurality of traffic profiles, to the plurality of devices of interest, the second signals causing the plurality of devices of interest to leave the low power mode for a normal power mode during second times.

29. A monitoring server of a network, the monitoring server comprising:
a memory; and
at least one processor, coupled to the memory, and operative to:
obtain usage data from a plurality of traffic sensors associated with a plurality of devices of interest of a plurality of network users;
based on the obtained usage data, create a plurality of traffic profiles for the plurality of devices of interest of the plurality of network users;
from time to time, cause first signals to be sent, based on the plurality of traffic profiles, to the plurality of devices of interest, the first signals causing the plurality of devices of interest to enter a low power mode during first times; and
from time to time, cause second signals to be sent, based on the plurality of traffic profiles, to the plurality of devices of interest, the second signals causing the plurality of devices of interest to leave the low power mode for a normal power mode during second times.

30. The server of claim 29, wherein the low power mode uses fewer spectrum resources than are used in the normal power mode.

31. The server of claim 30, wherein the low power mode consists of use of only a single channel and the normal power mode comprises use of at least two channels.

32. The server of claim 30, wherein the at least one processor is operative to create the plurality of traffic profiles by applying a binning procedure.

33. The server of claim 30, wherein the at least one processor is operative to create the plurality of traffic profiles by applying a machine learning procedure.

34. The server of claim 30, wherein the at least one processor is operative to create the plurality of traffic profiles by identifying the first times as less busy than the second times.

35. The server of claim 30, wherein the at least one processor is further operative to, from time to time, cause third signals to be sent, based on the plurality of traffic profiles, to the plurality of devices of interest, the third signals causing a plurality of backup batteries to be tested during the first times to determine corresponding battery states, the plurality of backup batteries being associated with the plurality of devices of interest.

36. The server of claim 35, wherein the at least one processor is further operative to, from time to time, cause fourth signals to be sent, based on the backup battery testing, the fourth signals causing replacement to be initiated for a failing subset of the plurality of backup batteries.

37. The server of claim 30, wherein:
the network comprises a hybrid fiber-coaxial network;
the devices of interest comprise cable modems; and
the first and second signals are sent via at least one cable modem termination system of the hybrid fiber-coaxial network.

38. The server of claim 30, wherein the at least one processor is further operative to:
obtain an indication of a power failure at one of the plurality of devices of interest; and
responsive to obtaining the indication of the power failure, cause a fifth signal to be sent, the fifth signal causing the one of the plurality of devices of interest having the indicated power failure to enter another low power mode.

39. The server of claim 30, wherein the at least one processor is further operative to, from time to time, to cause sixth signals to be sent, based on the plurality of traffic profiles, to the plurality of devices of interest, the sixth signals causing the plurality of devices of interest to enter an intermediate power mode during third times, wherein the intermediate power mode uses fewer spectrum resources than are used in the normal power mode and more spectrum resources than are used in the low power mode.

40. The server of claim 30, wherein the at least one processor is further operative to:
obtain an indication of a partial power failure at one of the plurality of devices of interest, the partial power failure comprising a non-zero but out of specification voltage; and
responsive to obtaining the indication of the partial power failure, cause a seventh signal to be sent, the seventh signal causing at least a component replacement to be initiated for the one of the plurality of devices of interest.

41. An apparatus comprising:
a cable modem;
a switch;
a power supply unit port selectively coupled to the cable modem through the switch;
a battery selectively coupled to the cable modem through the switch;
a processor coupled to the switch and the cable modem; and
a sensor coupled to the power supply unit port and the battery and configured to sense a power supply unit failure condition;
wherein the processor is configured to implement a traffic sensor and provide, to a monitoring server of a network to which the apparatus is coupled, usage data from the traffic sensor; and
wherein the cable modem is configured to:
from time to time, obtain at least a first signal from the monitoring server of the network, the at least first signal causing the cable modem to enter a low power mode during at least a first time, based on a traffic profile created for the device of interest using the usage data; and
from time to time, obtain at least a second signal from the monitoring server of the network, the at least second signal causing the cable modem to leave the low power mode for a higher power mode during at least a second time, based on the traffic profile.

42. The apparatus of claim 41, wherein the processor is further configured to:
obtain from the sensor an indication of the power supply unit failure condition; and
responsive to obtaining the indication of the power supply unit failure condition:
cause the switch to switch from connecting the power supply unit port to the modem to connecting the battery to the modem; and
advise the monitoring server of the power supply unit failure condition; and
wherein the cable modem is further configured to enter another low power mode responsive to a fifth signal caused to be sent by the monitoring server based on the monitoring server being advised of the power supply unit failure condition.

43. The apparatus of claim 42, wherein the cable modem, the switch, the power supply unit port, the battery, the processor, and the sensor are implemented as a single unit.

44. The apparatus of claim 42, wherein the cable modem is implemented as a first unit, and the switch, the power supply unit port, the battery, the processor, and the sensor are implemented as a separate second unit coupled to the first unit with an Ethernet cable.

45. The apparatus of claim 44, wherein the first unit and the second unit are cooperatively configured for the second unit to at least partially power the first unit over the Ethernet cable.
